(19) United States
(12) Patent Application Publication
(10) Pub. No.: US 2012/0135382 A1
(43) Pub. Date: May 31, 2012

(54) INDIVIDUALIZED MASTERY-BASED DRIVER TRAINING

(75) Inventors: Flaura Koplin Winston, Narberth, PA (US); Dennis Robert Durbin, Philadelphia, PA (US); David Phillip Lanter, Voorhees, NJ (US)

(73) Assignee: The Children's Hospital of Philadelphia, Philadelphia, PA (US)

(21) Appl. No.: 13/320,389

(22) PCT Filed: May 12, 2010
(86) PCT No.: PCT/US10/34526

§ 371 Date: Dec. 6, 2011

Related U.S. Application Data
(62) Division of application No. 61/177,406, filed on May 12, 2009.

(51) Int. Cl. G09B 9/04

(52) U.S. Cl. 434/65

(57) ABSTRACT

Driver training methods, systems, and computer readable media are disclosed. A training method receives sensor information from a vehicle driven along a driving route by an individual, assesses performance of the individual based on the sensor information and an individual mastery level, and adjusts the individual mastery level based on the assessed performance of the individual. The method may be embodied in a computer readable media. A driver training system includes a receiver that receives vehicle sensor information associated with a vehicle being driven along a driving route by an individual and a processor coupled to the receiver that assesses performance of the individual based on the received sensor information and an individual mastery level and adjusts the individual mastery level based on the assessed performance of the individual. Driver training protocols and systems and methods for implementing and transforming driver training protocols are also disclosed.

### RELATED APPLICATIONS

This application claims priority under 35 U.S.C. §119 to U.S. Provisional Application No. 61/177,406, filed on May 12, 2009, which is incorporated by reference herein, in its entirety and for all purposes.

### FIELD OF THE INVENTION

The present invention relates to the field of driver education and, more particularly, to driver training methods and systems.

### BACKGROUND OF THE INVENTION

Motor vehicle crashes are the leading cause of death for adolescents in the US with more than 5000 deaths per year, most occurring in crashes with 14-19 year old drivers. More than 70% of these fatal crashes are due to teen driver error, e.g., poor speed management and poor scanning. Further emphasizing the importance of inexperience and poor skill, the highest lifetime fatal crash risk occurs in the first six months or the first 1000 miles after receiving a license. Therefore, driver education and training, aimed at ensuring mastery of driving skills before licensure, should be an important component of a strategy to prevent teen crashes.

Unfortunately, conventional driver training follows a loosely organized, apprenticeship-like training model. There is minimal coordination, accountability, oversight, evaluation or quality improvement. As such, it is not known what constitutes effective driver education and training, and no evidence-based standards exist for training and practice. Some recommendations exist based on expert consensus for what constitutes best practices but no program integrates these best practices into education and training, ensures compliance with the training, or evaluates and improves upon the effectiveness of the recommendations. Further, state and other requirements for driver education and training vary greatly, further compounding the difficulty with standardization, oversight, evaluation, and quality improvement. Typical driver training programs include six (6) hours of professional instruction, which many consider an insufficient amount of time to teach the necessary skills for such a complex task as driving. Further, such programs do not demonstrate effectiveness in reducing crashes. Additionally, only 62% of teen drivers take driver training programs as many states no longer require them.

As a result, an additional challenge to ensuring high quality driver training and mastery prior to licensure is an increased reliance on parents in the process of teaching teens to drive even though most parents lack the training to teach and assess mastery of driving skills. Despite this, states typically require a minimum number of hours of adult-supervised practice prior to licensure and, based on a national survey of parents, parents estimate spending an average of 61 hours practicing driving with their teens. In order for this practice to effectively move teens toward driving skill mastery, parents need to ensure an adequate quantity, quality and variety of practice driving and assure that the teens demonstrate driving skill mastery while practicing with an adult before driving solo, without adult supervision, in a range of environments that pose different driving challenges and complexities.

The inventors' research with families has revealed that parents feel unprepared to supervise driving for multiple reasons, including lack of knowledge about how to teach driving skills, assess skill performance and mastery, provide feedback to improve performance, find appropriate routes for the teen's skill level, and how to track practice and progress. Further, they are challenged to find the time to teach their teens to drive and, thus, have limited additional time to acquire the necessary skills for effectively doing so.

Additionally, the inventors are unaware of suitable driver training techniques is for rehabilitating/retraining individuals who are former/existing drivers who need to re-learn driving skills or require remedial training after an event (e.g., illness, injury, or an at-fault crash), providing advanced training to individuals who already know how to drive for certifications (e.g., for commercial purposes, insurance rate reductions, etc.), educating driver trainers (e.g., parent and driving instructors), and preventing deterioration of the driving skills of the elderly.

Therefore, there is a need for improved driver training techniques.

### SUMMARY OF THE INVENTION

The present invention is embodied in driver training methods and systems. An exemplary driver training method includes storing a plurality of standardized training protocols, enabling selection and modification of the plurality of standardized training protocols to train driving trainees, tracking driving statistics associated with the driving trainees trained using the selected and modified standardized training protocols, and transforming one or more of the plurality of standardized training protocols based on the tracked driving statistics.

An exemplary driver training system to deliver this method includes a knowledge resource library including a plurality of standardized training protocols and a driver training program that trains driving trainees, the driving training program selecting and modifying one or more standardized training protocols from the plurality of standardized training protocols in the knowledge resource library. The knowledge resource library may additionally include federal, state, and other guidelines, recommendations, and standards.

Another exemplary driver training method receives vehicle sensor information, at a computer system, from a vehicle being driven along a driving route by an individual, assesses performance of the individual based at least in part on the received sensor information and a mastery level of the individual, and adjusts, by the computer system, the mastery level of the individual based at least in part of the assessed performance of the individual. The method may be embodied in a computer readable media.

Another exemplary driver training system includes a receiver that receives vehicle sensor information associated with a vehicle being driven along a driving route by an individual and a processor coupled to the receiver that assesses performance of the individual based at least in part on the received sensor information and a mastery level of the individual and adjusts the mastery level of the individual based at least in part of the assessed performance of the individual.

The methods and systems, in accordance with some embodiments, provide individualized driver education, skills training and programs to guide trainees, instructors, and others involved in training and education from preparing for a first day behind the wheel through training and practicing to the provision of full privileges of independent, non-supervised driving. Additionally, the methods and systems may be utilized for rehabilitating/retraining individuals who are former/existing drivers who need to re-learn driving skills or require remedial training after an event (e.g., illness, injury, or an at-fault crash), providing advanced training to individuals who already know how to drive for certifications (e.g., for commercial purposes, insurance rate reductions, etc.), educating driver trainers (e.g., parent and driving instructors), and preventing deterioration of the driving skills of the elderly.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following figures:

FIG. 1A is a block diagram of a driver training system in accordance with aspects of the present invention;

FIG. 1B is a block diagram of an exemplary program-specific training level generator for use in the system of FIG. 1A;

FIG. 1C is a block diagram of an exemplary individualized training rules generator for use the system of FIG. 1A;

FIG. 1D is a block diagram of an exemplary individualized training level rules generator for use in the system of FIG. 1A;

FIG. 1E is a block diagram of an exemplary quality improvement plan generator for use in the system of FIG. 1A;

FIG. 2 is a block diagram of an exemplary driver trainee system in accordance with an aspect of the present invention, including a base system, a mobile system, and an optional remote system in its full configuration;

FIG. 3 is a block diagram of an exemplary trainee base system for use in the exemplary driver trainee system of FIG. 2;

FIG. 4 is a block diagram of an exemplary trainee mobile system for use in the exemplary driver trainee system of FIG. 2;

FIG. 5 is a flow chart of exemplary steps for training drivers in accordance with an aspect of the present invention; and

FIG. 6 is a flow chart of exemplary steps for the step of generating a driving route in the flow chart of FIG. 5.

### DETAILED DESCRIPTION OF THE INVENTION

As a general overview, exemplary aspects of the invention may be embodied in adaptable, integrated, network-enabled (e.g., the Internet/web) knowledge management and quality improvement systems for structuring personalized, step-wise, performance-based driver training in order to achieve driving skill mastery and improved safety. Driver training in accordance with aspects of the present invention proceeds through a series of standardized achievement/mastery levels, each with progressive demands, challenges, and complexity. As used herein the term mastery level refers to levels much like those used in other forms of education that differentiate beginners from those who are more advanced and provide education and training content appropriate for the student or trainee's ability. A mastery level may be set based on performance and, optionally, experience. For example, expectations for performance of maneuvers and the provision of training (such as for right turns) by brand new learner drivers (trainees at the lowest mastery level) would be much different from that for teens with tens of hours of driving experience (trainees at an intermediate mastery level) or that of an experienced adult driver (those at a higher mastery level). By extension, progression to the next mastery level may depend upon the trainee's demonstration of adequate performance under specific conditions. Progression may further depend on such performance for a defined period (e.g., of time and/or distance). Further, the range of maneuvers and the complexity and challenge of the driving conditions under which training would occur will vary according to the achieved levels.

The driver training systems described herein may be adaptable to achieve one or more goals including, for example, teaching individuals such as teens to drive (e.g., with an instructor and/or parent), rehabilitating/retraining individuals who are former/existing drivers who need to re-learn driving skills or require remedial training after an event (e.g., illness, injury, or an at-fault crash), providing advanced training to individuals who already know how to drive for certifications (e.g., for commercial purposes, insurance rate reductions, etc.), educating driver trainers (e.g., parent and driving instructors), and preventing driving skills deterioration of the elderly. Although the present invention is primarily described below with examples for teaching a teen to drive, adaptations for achieving other goals (e.g., for rehabilitation and advanced training) will be understood by one of skill in the art from the description herein.

For a given driver training goal, the training process may be described through standardized training protocols that can be adapted to the unique needs of the driver training institution/school/program, trainer, and/or trainee. Parameters that describe the standardization process (e.g., measurable achievements and time milestones) when systematically measured can be translated into routines that supports tasks such as is training management, budgeting (e.g., resources, time, money, grades, or insurance discounts or other incentives), coordination, quality improvement, and certification and licensure. Driver training is an evolving field and the standardized protocols may be periodically updated based on results identified over time. For example, if it is determined that a modification to the driver training protocol results in reduced crashes, injuries, and/or fatalities (e.g., based on accumulated statistics corresponding to that modification), one or more of the standardized protocols may be revised to include that modification or results could be used to inform adaptations of government or other curricula, guidelines, or standards.

On an individual trainee level, the present invention provides improvements in driving mastery and safety. In an exemplary embodiment, each trainee has a personalized, driving training plan based on one of the standardized training protocols. The driving plan includes multiple mastery levels, e.g., ranging from beginner (level 1, for example) to course mastery (level 10, for example). In an exemplary embodiment, to achieve course mastery, a trainee needs to successfully complete/master each mastery level within the plan based on a measurable performance assessment and, optionally, a minimum period of experience (e.g., time and/or distance). For safety, a trainee can progress to a higher training mastery level only after achieving mastery of all previous mastery levels. Additionally, the trainee may be assigned a remedial plan if critical performance issues are identified.

On a system level, the present invention supports quality improvement in driver training. Conventional driver training follows a loosely organized, largely unevaluated, apprenticeship-like training model. However, there is minimal coordination, communication, evaluation of effectiveness, or standardization with such models. The present invention solves this problem thorough adaptable standardized training plans that can be personalized to the unique needs of the trainee. These plans may document the step-by-step process of training to standardize assessments which, in turn, drive the process and measure outcomes. Quality improvement procedures may identify variances (compliance or effectiveness) between the training process and the measurable outcomes and trigger improvement protocols. Additionally, automated identification of quality improvement needs may be incorporated (e.g., when a driving trainee follows a prescribed training route and crashes, when the system is unable to make a training recommendation, or when a school/trainer/trainee identifies a problem).

The present invention enables the creation, storage, and manipulation of driving and driver training knowledge and driver trainee data through a database. This knowledge representation allows a range of users (e.g., trainee, trainer, school, supervisor, credentialing/licensing officer, government official, or insurer) to interact with the knowledge according to set privileges in order to acquire, establish, and use information throughout the training process that reflect the concept of skill mastery through a series of levels/steps. For example, a driver trainer can review a trainee's progress and advance his training plan to a new level of complexity according to rules established by a supervisor or credentialing/licensing officer. The driver training process in accordance with one aspect of the invention may be automated by transforming data from the process into a knowledge representation maintained in a database containing collected, organized and stored information and adaptable rules about the use of the data in the database. As a knowledge representation, the collected data are represented in a manner that can feed the instructions for the progressively complex training process through an established leveling structure. The automated functions translate disparate data in the knowledge representation into actionable, real-world step-wise instructions for those involved in the training process.

Automation of the individualized, mastery-based driver training process may be accomplished through a set of routines (e.g., computer software modules) to encode the processing steps (e.g., for the specific embodiments of the program by a driving school) delivered via a computer-assisted learning environment. Automation may also involve routines to manipulate the structure of the knowledge to make inferences and generate instructions based on these inferences. The program may be sufficiently flexible to allow customization by any training facility that utilizes the invention, for the specific training programs within each facility, and individualized programs for each of the trainees enrolled in the facility. For example, routines may be implemented to: (1) establish training standards for each specific embodiment of a training program; (2) specify baseline needs and prescribe a training plan for each enrollee in the program in accordance with established standards; (3) revise the trainee's plan as the training progresses thorough the program according to defined assessments and rules; (4) conclude the trainee's training according to defined assessments and rules; (5) perform individual and program-level quality assurance procedures; and (6) adapt, revise, and/or update the training program, as necessary.

Specific embodiments of the present invention are now described.

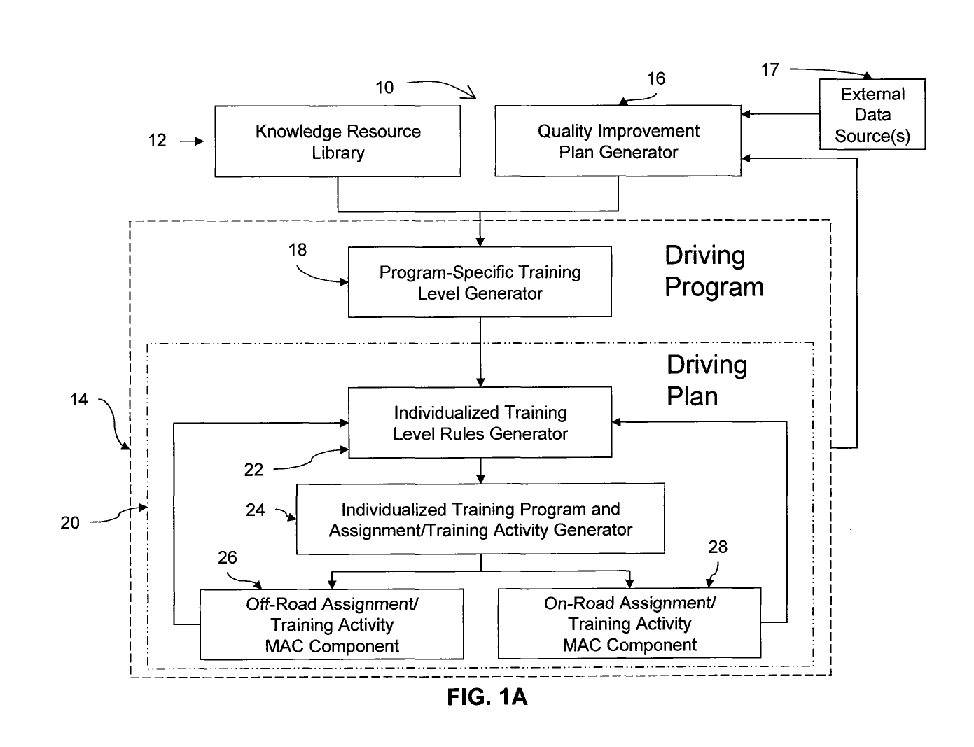

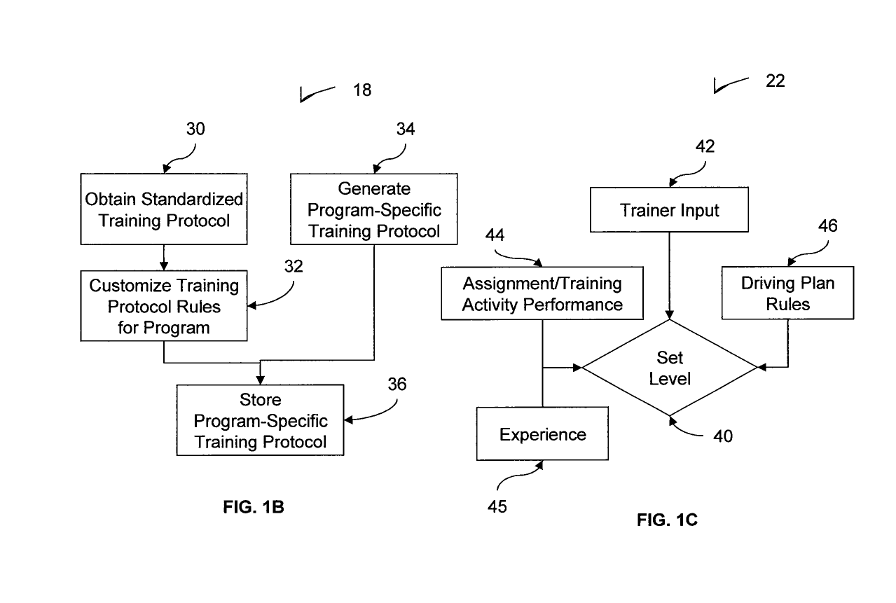

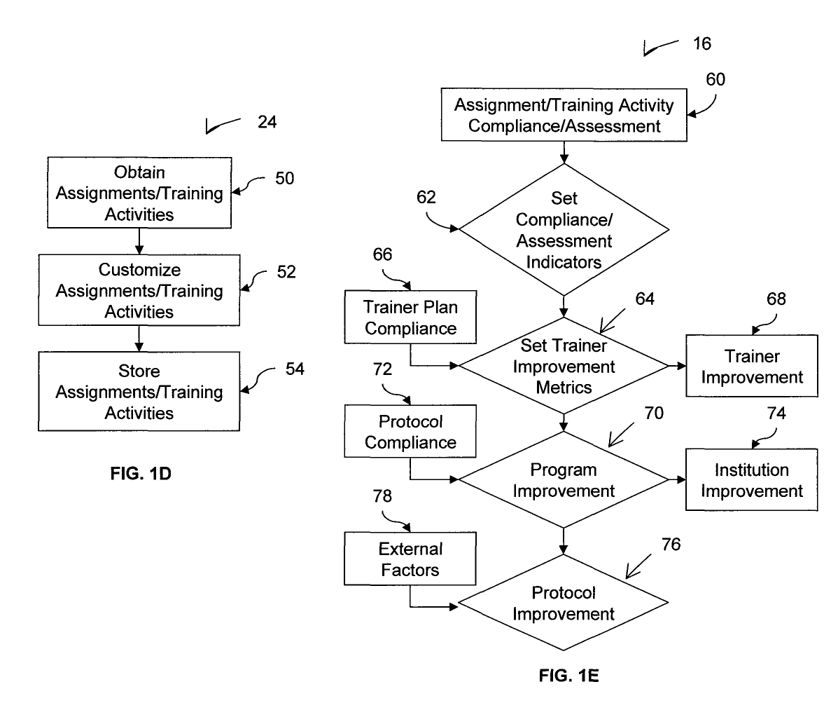

FIG. 1A is a block diagram depicting an exemplary mastery-based driver training system 10. System 10 includes a knowledge resource library 12, a driving program 14, a quality improvement plan generator 16, and external data source(s) 17.

Knowledge resource library 12 includes standardized training protocols, and may include other resource materials for those involved in training. Library 12 may be stored on a conventional computer server accessible via a network such as the Internet or an intranet. An exemplary standardized training protocol may include a plurality of “mastery” levels. Each mastery level may include one or more assignments and/or training activities (collectively, “interventions”) that need to be satisfactorily completed in order to progress to the next mastery level (e.g., based on input from industry experts or scientific evidence) that are believed to most likely result in optimal training (e.g., based on skill mastery, safety statistics, and satisfaction) at a minimal cost in terms of resources, time, and personnel, for example. As the trainee progresses through the mastery levels, the assignments and/or training activities associated with each mastery level become increasingly complex and challenging.

Assignments or training activities may include activities that occur in the context of education/training with an instructor, at school, at work, at a department of motor vehicles (DMV), etc. and assignments assigned by trainer for the trainee to complete outside class time. Assignments may include on-road assignments such as instructional or practice drives or off-road assignments such as watching a training video or a quiz. Each assignment or training activity assignment or training activity includes one or more components such as an assignment component, a behavior component, and an assessment component (e.g., quantitative values based on exam completion or sensor feedback and/or qualitative information based on trainer feedback, which is described in further detail below). For example, if the assignment or training activity assignment or training activity is a practice drive: the assignment component may be a particular route the trainee is to drive; the behavior component may include speed management, following distance, lane handling, and scanning; and the assessment component may include a passing/failing assessment for speed management and following distance obtained from vehicle sensors and/or a passing/failing assessment for lane handling and scanning obtained from the trainer.

Library 12 may include multiple standardized protocols. For example, library 12 may include five standardized protocols: (1) a protocol for teaching individuals such as teens to drive, (2) a protocol for rehabilitating/retraining individuals who are former/existing drivers who need to re-learn driving skills or require remedial training after an event, (3) an advanced training protocol for individuals who already know how to drive for certifications, (4) an education protocol for educating driver trainers, and (5) a protocol for preventing driving skills deterioration of the elderly. Library 12 may include fewer or more standardized protocols. For example, the library may include a protocol for teaching a teen to drive with their parent and a separate protocol for teaching a teen to drive with a professional instructor. Additionally, library 12 may include different protocols for trainees with varying types or degrees of challenges to fitness to drive, such as attention deficit/hyperactivity disorder or with other disabilities or learning differences, those for drivers recovering from head injuries or stroke, or for those who have lost a limb. Other types of protocols will be understood by one of skill in the art from the description herein.

Information in library 12 may additionally include applicable laws and policies, scientific literature, on-line forums and discussion groups, and commercial and financial information. This information may be made available to driver schools, trainers, and trainees, and may be used in developing the standardized protocols.

Driving program 14 includes a program-specific training level rules generator 18 and a personalized, mastery-based driving plan 20. Driving program 14 may be implemented by public or private institutions such as public high schools, governmental transportation departments, private driver training schools, rehabilitation hospitals, etc.

Using program-specific generator 18, (which may be implemented through software running locally on a computer, not shown, and/or running remotely on a computer server, not shown, and accessed via a network) an institution may receive/download one or more standardized training protocols from library 12. FIG. 1B depicts an exemplary program-specific generator 18. At block 30, one or more standardized training protocols are obtained, e.g., from library 12 (FIG. 1A). For example, if an institution is going to train only new drivers, the institution may download only the driver training protocols applicable to new drivers. At block 32, the obtained standardized training protocols are optionally modified. For example, if an institution believes that at least 50 hours of on-road driver training is required and a particular standardized training protocol only requires 40 hours of on-road driver training, the institution may modify that standardized training protocol to require 50 hours of on-road driver training. Alternatively, the institution may accept the standardized training programs without modification, in which case block 32 may be omitted.

At block 34, the institution may optionally create one or more of their own training protocols.

At block 36, the training protocols are stored for selection. In an exemplary embodiment, modifications to the training protocols are recorded for future assessment to see if these modifications result in improved driving (e.g., based on accident/casualty statistics) and, if so, for consideration as modifications to the standardized training protocols stored in library 12.

Referring back to FIG. 1A, personalized, mastery-based driving plan 20 may be used to develop a plan specifically tailored to a particular driver trainee. Additionally, personalized plan 20 may be used to assign assignments and/or training activities, monitor performance of the trainee on assignments and/or training activities, assess performance of the trainee upon completion of assignments and/or training activities, and monitor compliance. Illustrated mastery-based plan 20 includes an individualized training level generator 22, an individualized training program and assignment/training activity generator 24, an off-road training assignment/training activity monitoring/assessment/compliance (MAC) component 26 (e.g., for driving simulator practice or video/quiz assignments) and an on-road assignment or training activity MAC component 28 (e.g., professional behind-the-wheel instruction or supervised practice driving).

Individualized training level generator 22 may be used to assign a mastery level to a trainee. FIG. 1C depicts an exemplary individualized training level rules generator 22. At decision block 40, a trainee's mastery level is set. The mastery level may be based on trainer input 42, assignment/training activity performance 44, experience (e.g., in time and/or distance) 45, and/or driving plan rules 46. Initially, mastery level may be automatically assigned based on plan rules 46 to a beginner level, e.g., level 1. The level may be modified by a trainer's input 42, e.g., if the trainee is transferring from another school and it is appropriate to assign an advanced level. Thereafter, the mastery level may be updated manually, e.g., based on feedback from the trainer regarding performance of trainee on assignments and/or training activities (described below with respect to off-road assignment/training activity MAC 26 and on-road assignment/training activity MAC 28), automatically, e.g., based on automated review of assignment and/or training activity feedback from vehicle sensors in accordance with plan rules, or both (either separately or in combination).

Referring back to FIG. 1A, using individualized training program and assignment generator 24 (which may be implemented through software running locally on a computer, not shown, and/or running remotely on a computer server, not shown, and accessed via a network) a trainer may select a standardized training protocol from program-specific generator 18 for use in training a driver trainee. FIG. 1D depicts an exemplary individualized training program and assignment/training activity generator 24. At block 50, training assignments/training activities are obtained. The trainer may select the standardized training protocol (as modified by the institution, if applicable) including training assignments/training activities based on an interview with the driver trainee, for example. At block 52, the trainer optionally customizes the standardized training program to suit the needs of the trainee. For example, if the trainer believes the trainee will require extra practice parallel parking, that portion of the standardized training protocol may be customized. At block 54, the selected standardized protocol (as customized by the institution and/or trainer) is stored. In an exemplary embodiment, customizations to the training protocol are recorded for future assessment to see if these customizations result in improved driving (e.g., based on accident/casualty statistics) and, if so, for consideration as modifications to the standardized training protocols stored in library 12.

Referring back to FIG. 1A, off-road MAC component 26, which may be implemented in software on a computer, monitors performance of the trainee on off-road assignments and/or training activities, assesses the performance of the trainee on the off-road assignments/training activities, and determines compliance of the off-road assignment/training activity with standardized off-road assignment/training activity criteria. Exemplary off-road assignments/training activities may include attending driver training classes, taking quizzes, watching videos, practicing driving on a stationary driving simulator. Such assignments/training activities may be monitored, for example, by keeping track of class room attendance, recording scores on quizzes, keeping track of videos watched, and recording data generated by a stationary driving simulation and may be assessed by, for example, indicating successful completion if 90% or more classes attended, score of 80% or greater on all quizzes, all assigned videos watched, suitable data returned by stationary driving simulator, respectively. Off-road assignment component 26 may identify remedial actions, e.g., additional videos or simulator training, if one or more off-road assignments/training activities are not initially completed successfully. Compliance information may be stored for plan improvement (described below).

On-road MAC component 28, which may be implemented in software on a computer (not shown), monitors performance of the trainee on on-road assignments and/or training activities, assesses the performance of the trainee on the on-road assignments/training activities, and determines compliance of the on-road assignment/training activity with standardized on-road assignment/training activity criteria. Exemplary on-road assignments/training activities include one or more driving assignments/training activities. For example, the on-road assignments/training activities may include a first driving assignment/training activity that focuses on left turns (left turn intervention) and a second assignment/training activity that focuses on parallel parking (parallel parking intervention). Such assignments/training activities may be monitored and assessed, for example, by automatically monitoring sensor information received from sensors associated with the vehicle and/or manually receiving feedback from a driving instructor accompanying the trainee. For example, a left turn assignment/training activity may include automatic monitoring and assessment information indicating the acceleration experienced throughout each left turn to see if turns where smooth or erratic with the percentage of smooth turns exceeding 90% assessed as satisfactory completion of the left turn intervention. Manual monitoring and assessment may also be considered. For example, if the trainee made a left turn through a red light. If both automatic and manual monitoring and assessment are performed, the driver trainee would have to successfully pass both the manual and automatic portions in order to successfully complete the intervention. On-road MAC component 26 may identify remedial actions, e.g., a videos or simulator training, if one or more on-road assignment/training activity is not initially completed successfully. Compliance information may be stored for plan improvement (described below).

Quality improvement plan generator 16 may implement quality improvements routines to utilize the data collected throughout the training system 10 to measure variables in compliance (e.g., how well a trainee follows assignments or whether a trainer prescribed assignments in accordance with standardized processes and techniques) and/or variances in effectiveness (e.g., how well the standardized processes and techniques achieve the desired outcomes, most notably driving skill mastery and safety). Quality improvement plan generator 16 also may utilize information from external data source(s) 17 such as applicable laws and policies, scientific literature, on-line forums and discussion groups, commercial and financial information, and DMV driver records, for example. Additionally, quality generator 16 may be used for both development and management. For development, the routines may be used to hone standardized plans and optimize outcomes through research studies. On-going effectiveness assessments can be used to indicate opportunities for improvements or the need for further development when effectiveness goals are not met or where external changes (e.g., new laws, available products, or scientific findings) dictate need for plan revisions. For management, identified non-compliance trigger routines may be implemented to provide feedback, support, and remedial actions.

FIG. 1E depicts an exemplary quality improvement plan generator 16. At block 60, assignment and compliance data are obtained from off-road MAC component 26 (FIG. 1A) and on-road MAC component 28. At block 62, compliance and assessment indicators (described below) are set based on the obtained assignment and compliance data. At block 64, trainer improvement metrics are set based on the set compliance and assessment indicators 62 and the trainer's compliance with the standardized protocol when developing a trainee's plan. At block 68 a trainer improvement plan is developed.

At block 70, program improvements are considered based on set trainer improvement metrics 64 and protocol compliance 72 (e.g., compliance by the institution with standardized protocol). At block 74, an institution improvement plan is developed.

At block 76, protocol improvements to knowledge resource library 12 (FIG. 1A) are made based on program improvement 70 and/or external factors 78 such as applicable laws and policies, scientific literature, on-line forums and discussion groups, commercial and financial information, and DMV records received from external data source(s) 17. For example, one or more of the plurality of standardized training protocols in the knowledge resource library may be transformed using a computer based on the tracked driving statistics by storing a plurality of standardized training protocols in the is knowledge resource library, enabling selection and modification of the plurality of standardized training protocols to train driving trainees, and tracking driving statistics associated with the driving trainees trained using the selected and modified standardized training protocols.

In an exemplary embodiment, the standardized protocols include a set of rules for training (content and progression), e.g., what is needed to complete the goals of training and how to individualize the training for a given trainee. These rules may be embodied in algorithms driven with input parameters (indicators), which are described in further detail below. Algorithms may be used to automatically select a standardized training protocol or to assist a trainer in selecting an appropriate protocol and mastery level within the protocol. Indicators may also be used as summary measures of interim (periodic, throughout the training) assessments of the trainee across multiple domains that would aid in ensuring that the training meets the individual trainee's needs as the trainee progresses through the program.

In one embodiment of the system, user training data is linked to external data sources 17 in order to monitor longer term driving performance as measures of the effectiveness of the training. Examples of these outcomes may include scores on exams for passing licensing, certification or medical clearance examinations and other driving outcomes, including crashes and citations. This capability would enable the system to identify protocols associated with lower-than-expected adverse outcomes (e.g., protocols that may be successful in producing more competent or safer drivers), as well as protocols associated with higher than expected adverse outcomes that may require modification for quality improvement.

As an example of this embodiment, the user may provide the necessary permissions and required information needed for the system (or its operators) to gain access to an external data source 17 or to link the driver training system to an external data source 17. Exemplar external sources of data may include police crash reports and citations, typically collected and stored by local and/or statewide motor vehicle licensing and/or law enforcement agencies, as well as insurance claims records maintained by insurance companies. Provision of a driver license number and/or insurance policy number by a system user would provide the capacity for the proposed system to access these existing sources of data for automated updates when events of interest (crashes or citations) occur either automatically or manually. An additional table of outcome variables could be included in the system's database and would be linked to the trainee by a unique user id, for example. Standard procedures could be implemented to ensure privacy and confidentiality of the information (for example, the links between the user id and the identifying information could be maintained in a separate system).

On an individual trainee level, this capability could allow evidence-based provision of post-training privileges for a former trainee or provide remedial training, as needed. For example, authority to drive in more complex situations could be granted based on performance. As one embodiment, upon training completion and successful performance of a final assessment, licensing agencies, insurers, employer or parents could set limits on allowed driving conditions for a newly licensed trainee by sending time, GPS or other parameters from either base system 102 or remote system 106 to mobile system 104, which are described in further detail below. Mobile system 104 could send alerts to the driver and the licensing agency, insurer, employer or parent if driving exceeded the permitted parameters. The external data could be monitored to automatically or manually increase the range of permitted driving conditions. For example, if the new driver did not have a citation or crash in the first six months, privileges could be increased by changing the parameters sent to mobile system 104. Conversely, if the driver had a citation or crash, the driving privileges could be reduced or the driver could be automatically enrolled in remedial training and linked with a remedial training program in the system.

On a system level, this capability could be used for continuous quality improvement of the training system. For example, the 12 month driving outcomes for all previous trainees could be automatically or manually aggregated by training program and aggregated statistics could be compared. Training programs that produced trainees with higher or lower than average citations or crashes could be flagged in the knowledge resource library 12 with ratings (5 stars for higher than average and 1 star for lower than average, for example) and a message could be sent to the creator of the training program that improvements are needed in the program.

System 10 is a decision support system that links measurable observations about the trainee (summarized as indicators) to available knowledge about how to best train a student/trainee (given the set of indicators) and presents this information to trainers to influence them to make optimal choices for next steps in student training. In certain embodiments, system 10 may be considered cooperative in that the collected, analyzed data may be provided to humans (primarily the trainer, but also—as in route planning—the trainee) who interprets the analysis to prescribe actions.

System 10 may be comprised of an updateable repository of knowledge and an inferencing mechanism (a set of rules for evidence-based training), i.e., algorithms. These algorithms allow the trainer to make rational decisions for next steps in training based on indicators, for example. An algorithm might take the form of IF-THEN rules.

Exemplary indicators include baseline indicators, interim indicators, and completion indicators. Baseline indicators may be determined when a trainee joins a program, rejoins a program after a leave/vacation from the program, or transfers into a program from another program in order to place the trainee in the correct standardized protocol and initial level and set an initial individualized program of study. Interim indicators may be determined while the trainee is in midst of the program and may be used to set the trainee's current level and individualize the training according to the trainee's demonstrated needs that emerged during training or according to the progress that they are making towards mastery. Completion indicators may be determined at the completion of the program.

Examples of baseline indicators include baseline process indicators such as personal characteristics (age, disability, type of license, etc.) and location/state (which could be used to choose the appropriate laws and driving environments) and baseline mastery indicators such as knowledge (about driving risk, about laws, etc.) and experience driving (e.g., previous experience behind the steering wheel of a vehicle).

Examples of interim indicators include process interim indicators and mastery interim indicators. Process interim indicators include personal characteristics (e.g., a change from a baseline indicator: Age if reached age when qualify for another type of license during program; Disability—might now be on medication or have recovered some function; Type of license—might have passed an exam and now qualified to drive under certain conditions, etc.; or New characteristics that emerged that were not present at baseline), assignment compliance, and assignment completion. Mastery interim indicators include knowledge (e.g., about driving risks, about laws, etc.—the content of questions included in the assessment could differ from that asked at baseline) and experience driving (e.g., differences from baseline in the precision of what is measured—could use in-vehicle device to measure quantity, quality, and variety of practice driving, and provide a summary to date and/or broken down by specific environmental and/or other characteristics).

Example of completion indicators include process completion indicators such as completed program/instructor review and feedback on completed program components and mastery completion Indicators such as passed final exam, on the road assessment, or licensure or certification exam.

Exemplary algorithms for selecting standard protocols are now provided. A student's baseline assessment may be summarized as a series of baseline indicators (e.g., BASELINEINDi, where i=1 to n for each of the domains over which the student was assessed). The baseline indicators (BASELINEINDi) may be used as input parameters to the following algorithm to choose the correct protocol (among a family of standardized protocols, STANDPROTOCOLa; where a=1 to n for all of the available protocols):

IF BASELINEIND1 = x AND BASELINEIND2 = z
THEN GO TO STANDPROTOCOL = a AND START AT LEVEL = b
(where STANDPROTOCOL is a family of standardized protocols,
STANDPROTOCOLa, where a = 1 to n and where n is the number of
protocols in the library 12; and LEVELz is a series of progressive
training levels within
STANDPROTOCOLa, where z = 1 to m and LEVEL0 indicates start
of training and LEVELm indicates traininq goal achieved).

An example of how indicators could be used with algorithms according to a standardized protocol within a given levels is now described. Assume trainee X is in the middle of his training under STANDPROTOCOLa at LEVELz and trainee X has a series of associated Indicators (INDICATORi, where i=1 to n) that summarize assessments of his adherence to and performance with training; quantity, quality, and diversity of driving (e.g., both summary to date and by environment and other characteristics); and other measures of knowledge, attitudes, etc. For example, INDICATOR1 may indicate whether he completed all on-line assignments; INDICATOR2 may indicate whether he completed all in-vehicle assignments; and INDICATOR3 might indicate whether his driving performance was always green (through in-vehicle performance assessments); and INDICATOR4 might indicate whether he met a minimum number of hours and miles within assigned environmental conditions (e.g., roadway time, weather conditions, or time of day) or other characteristics (e.g., for gaining commercial certification or licensure, a condition might include the type of vehicle driven).

An exemplary algorithm using indicators to make assignments follows:

IF INDICATOR1 = YES and INDICATOR2 = YES and INDICATOR3 =
YES THEN GO TO NEXT ASSIGNMENT (ASSIGNMENTx)

ELSE
IF (INDICATOR1 = NO OR INDICATOR2 = NO OR

INDICATOR4 = NO) AND INDICATOR3 = YES THEN
SEND MESSAGE, “YOU ARE MAKING GOOD PROGRESS, PLEASE
COMPLETE THE ASSIGNMENTS”
IF INDICATOR3 = NO THEN

SEND MESSAGE TO STUDENT, “PLEASE CONTACT YOUR

INSTRUCTOR. IT APPEARS THAT YOU MIGHT BE HAVING SOME
CHALLENGES WITH THE ASSIGNMENTS.”
SEND MESSAGE TO INSTRUCTOR THAT A REMEDIAL LESSON
MIGHT BE NEEDED. PLEASE CONTACT STUDENT.

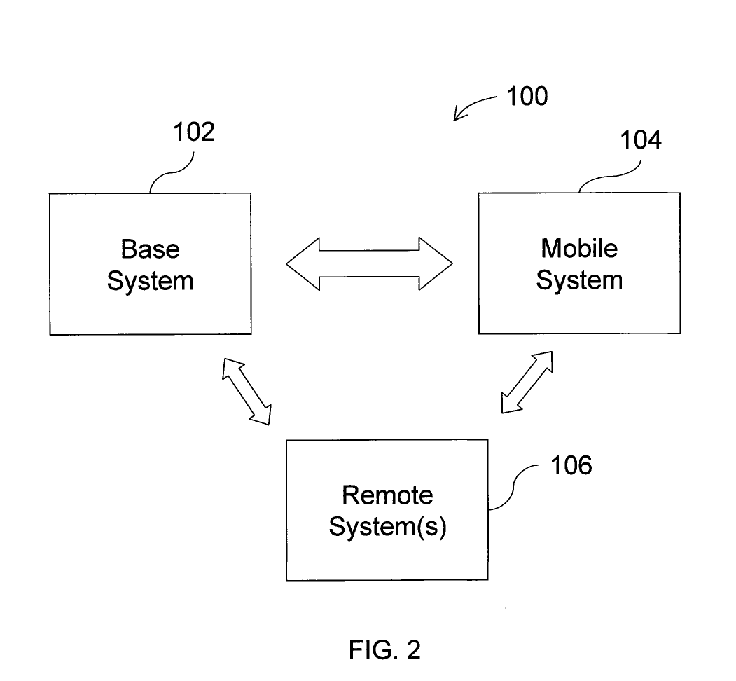

FIG. 2 depicts an exemplary driving trainee system 100 for use by trainees in completing off-road stationary driving simulation assignments and/or training activities and on-road driving assignments and/or training activities. Alternative systems for completing other types of assignments and/or training activities will be understood by one of skill in the art from the description herein. The illustrated driver trainee system 100 includes a trainee base system 102, a trainee mobile system 104, and an optional remote system(s) 106, which will be described in further detail below.

As a general overview, trainee base system 102 may be a stationary computer system located in a classroom or home, for example, (or, as another example, a server-based trainee system that supports multiple users in multiple locations and supports the trainees who access the system through thick- or thin-client networked- or Web-based applications) and trainee mobile system 104 may be a mobile computer system located in a vehicle being driven by a trainee (e.g., as original or aftermarket vehicle equipment or as a handheld device). In use, and as will be described in further detail below, base system 102 would be used by a trainee before each lesson or practice drive to prepare and after the lesson or practice drive to receive feedback. The system would automatically provide lessons and feedback tailored to the student's mastery level, goals, and performance. Base system 102 may generate a driving route appropriate for the training goals, mastery level, and experience of the individual and simulate the prescribed driving route to give the trainee experiences necessary for the development of particular skills or to familiarize the trainee with the driving route prior to actually driving a vehicle on a roadway. Such skill development may include virtual training to teach scanning for hazards or other skills needed to successfully complete the driving route. A series of base units might be networked to someone who needs to monitor or evaluate student progress (e.g., insurer, supervisor, evaluator, or teacher).

It will be understood by one of skill in the art from the description herein that base system 102 can function alone, e.g., based on data entered by an individual such as a driving instructor, parent, or the driver trainee. For example, if base system 102 does not communicate with mobile system 104 or remote system 106, but a driving instructor collects data during a drive, the driving instructor may enter this information into the system and the system could assess the information, e.g., for use in modifying a mastery level or prescribing different routes.

Mobile system 104 includes sensors (such as accelerometers, a speedometer, and global positioning information) that produce data associated with the vehicle (e.g., time- and date-stamped three-dimensional acceleration/deceleration and speed and location) as a result of the practice drive or lesson, and/or associated with the driver and/or occupant(s)). Mobile system 104 may receive information from base system 102, such as the prescribed driving route, and may communicate information about the trainee's performance while driving the vehicle back to the base system 102 for use in assessing performance of and providing post-drive feedback to the trainee and those involved in his training and the monitoring of his training. Mobile system 104 may function alone if it contains the functions of the base system 102 (e.g., a mobile computing or communication device can function as both base system 102 and mobile system 104).

In one embodiment, base system 102 communicates directly with mobile system 104, e.g., via two-way radio communication. In accordance with this embodiment, remote system(s) 106 may be omitted, or may be used to provide additional information such as global positioning system (GPS) signals for use by mobile system 104 to determine position and/or to provide processing services for use by base system 102 and/or mobile system 104. In an alternative embodiment, base system 102 communicates with mobile system 104 via a remote system(s) 106 such as cellular towers and/or a global information network such as the Internet. In accordance with this embodiment, remote system(s) 106 may additionally be used to provide information such as GPS signals and/or to provide additional processing of data for use by base system 102 and/or mobile system 104 or may send warnings or other information to those who need and/or desire to monitor the training. Additionally, remote system 106 may house resource library 12 or provide access to external data source(s) 17 (FIG. 1A) and/or provide functionality described with respect to FIGS. 1A-1E. Suitable remote systems 106 for use with the present invention will be understood by one of skill in the art from the description herein.

Details regarding an exemplary trainee base system 102 and mobile system 104 will now be provided.

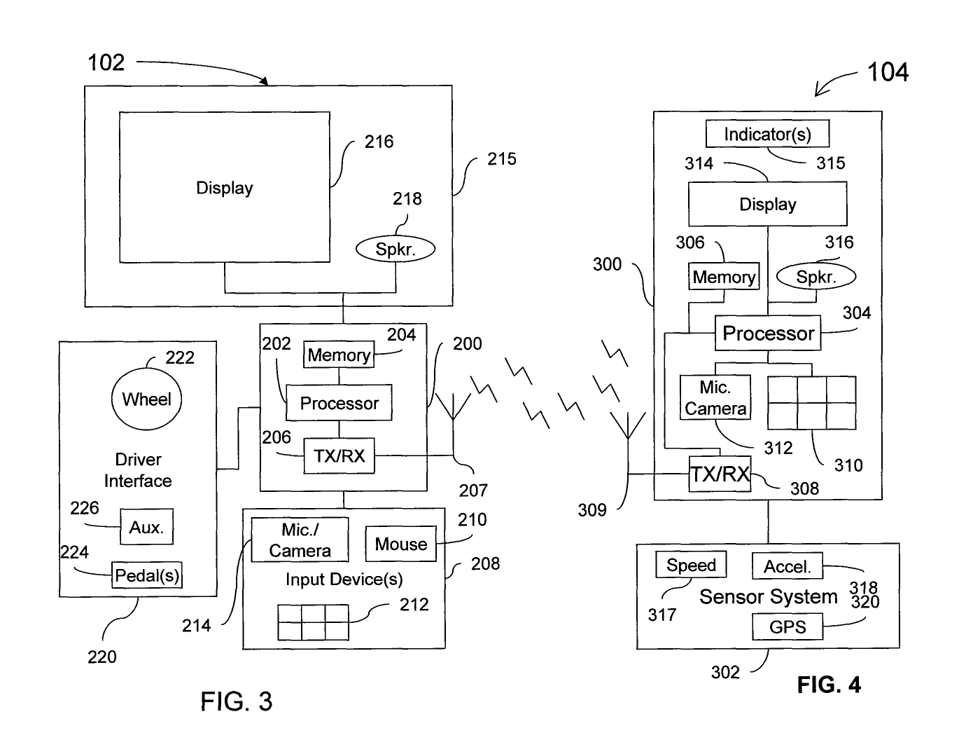

FIG. 3 depicts an exemplary trainee base system 102, which may be deployed in a classroom or a trainee's home or could be accessed remotely by a trainer or someone monitoring the training. Illustrated base system 102 includes a processing system 200 for processing instructions. The processing system 200 includes a processor 202 and a memory 204. Memory 204 stores data from processor 202 and provides previously stored data to processor 202. Processing system 200 further includes transceiver(s) 206 for communicating with other systems. Transceiver(s) 206 may be wired and/or wireless transceivers. For example, a cellular transceiver may be used that transmits and receives cellular communication signals via an antennae 207. Additionally, or alternatively, a network transceiver may be used to communicate via a global information network such as the Internet or via a local area network. Suitable processors, memories, and transceivers for use with the present invention will be understood by one of skill in the art from the description herein.

Illustrated base system 102 additionally includes input device(s) 208 for receiving information for processing by processing system 200 and output device(s) 215 for presenting information generated by processing system 200. Exemplary input device(s) 208 includes a mouse 210 and a keypad/keyboard 212 for receiving physical input from a trainee using base system 102 and a microphone or camera 214 for receiving auditory or is visual input. Exemplary output device(s) 215 includes a display 216 for visually presenting information from processing system 200 and a speaker 218 for presenting auditory output.

In one embodiment, the base system 102 stores and processes all instructions/algorithms needed for implementation of the functionality provided by base system 102. In another embodiment, the system may be “web-based” with storage and processing of some or all instructions/algorithms for providing base system 102 functionality occurring at one or more remote locations 106. Thus, base system 102 and a remote location 106 function as a computing system to provide the functionality of the base system 102 described herein. For example, processor 202 and display 216 of base system 102 may support a graphical user interface (GUI) for display of information originating from a remote location 106 and audio support may additionally be provided, e.g., via speaker 218, for training and feedback. In accordance with this embodiment, base system 102 may be essentially any electronic device capable of displaying information and receiving inputs from a user, such as a desktop computer, laptop computer, handheld computer, smart phone (e.g., an iPhone available from Apple Inc. of Cupertino, Calif., USA), or other such device.

Base system 102 may additionally include a driver interface 220. Driver interface 220 may simulate performance of a vehicle that could include a steering wheel 222, accelerator and brake pedals 224, auxiliary interfaces 226 and/or other driving Interfaces typically associated with a vehicle. The driving interface may be coupled to processing system 200 for use in receiving driving input information during a simulation utilizing base system 102, for example.

Base system 102 may be used to prescribe actions such as off-road and on-road assignments and/or training activities for performance by a trainee, assess performance of the trainee based on manual feedback provided by an instructor/parent or automatic feedback from system 100, monitor performance of trainee, keep historical record of trainee actions/performance, track trainee performance and compliance with a prescribed assignment or program of training, provide simulations for use by trainee, train the trainee, evaluate the trainee, provide course planning for the trainee, and provide output functions such as printing reports.

FIG. 4 depicts an exemplary trainee mobile system 104, which is associated with a vehicle used by a trainee being trained to drive. Illustrated mobile system 104 includes an interface system 300 and a sensor system 302 that may be operated in an actual vehicle. Interface system 300 includes a processor 304 for processing instructions and a memory 306. Memory 306 stores data from processor 304 and provides previously stored data to processor 304. Interface system 300 further includes transceiver(s) 308 for communicating with other systems. Transceiver(s) 308 may be wired and/or wireless transceivers. For example, a cellular transceiver may be used that transmits and receives cellular communication signals via an antennae 308. Additionally, or alternatively, a network transceiver may be used to communicate via a global information network such as the Internet. Suitable processors, memories, and transceivers for use with the present invention will be understood by one of skill in the art from the description herein.

Illustrated interface system 300 additionally includes a keypad/keyboard 310, microphone or camera 312, a display 314, indicator(s) 315, and a speaker 316. Keypad/keyboard 310 may be used to receive physical input from a trainee using mobile system 104 and/or another individual (e.g., a parent or driving instructor). Microphone and/or camera 312 may be used to receive auditory or visual input. Display 314 and indicator(s) 315 may be used to visually present information from processor 202. Speaker 316 may be used to present auditory output.

In one embodiment, the mobile system 104 stores and processes all instructions/algorithms needed for implementation of the functionality provided by mobile system 104. In another embodiment, the system may be “web-based” or networked with storage and processing of some or all instructions/algorithms for providing mobile system 104 functionality occurring at one or more remote locations 106. For example, processor 304 and display 314 of mobile system 104 may support a graphical user interface (GUI) for display of information originating from a remote location 106 and audio support may additionally be provided, e.g., via speaker 316, for training and feedback.

Sensor system 302 senses information associated with driving the vehicle such as speed via speed sensor 317, acceleration/deceleration (e.g., forward/backward/lateral) via accelerometer(s) 318, and position via GPS 320. In an exemplary embodiment, sensor system 302 is coupled to or incorporated into interface system 300. Alternatively, sensor system 302 may be a separate device that communicates information directly from sensor system 302 to base system 102 (either directly or via remote system(s) 106) without passing through interface system 300. Additional sensors (not shown) such as a seat belt use sensor and a breath alcohol sensor may additionally be incorporated into sensor system 302. Information sensed by sensor system 302 may be used for monitoring during driver education. For example, the sensed information may be fed into algorithms for prescribing lessons, for use by driving instructors in evaluating progress of a student, etc.

The mobile system 104 may additionally include at least one camera (not shown) for gathering images of the driver while driving the driving route and/or images from the view point of the driver while driving along the driving route. This information may be communicated to the base system 102 and/or to a remote system 106 for storage and/or communication to base system 102 for use in conjunction with reviewing a trainee's assessment.

In one embodiment, interface system 300 and sensor system 302 may be provided by a single self-contained unit. For example, it is contemplated that an iPhone with its graphical user interface, GPS functionality, speaker, and accelerometers, may be adapted in a manner understood by one of skill in the art from the description herein to provide the functionality of interface system 300 and/or sensor system 302. In another embodiment, the interface system 300 and/or sensor system 302 (or one or more components thereof) may be original equipment manufacturer (OEM) parts incorporated into the vehicle such as components within General Motors' OnStar system that enable communications, in-vehicle security, hands free calling, turn-by-turn navigation, and remote diagnostics.

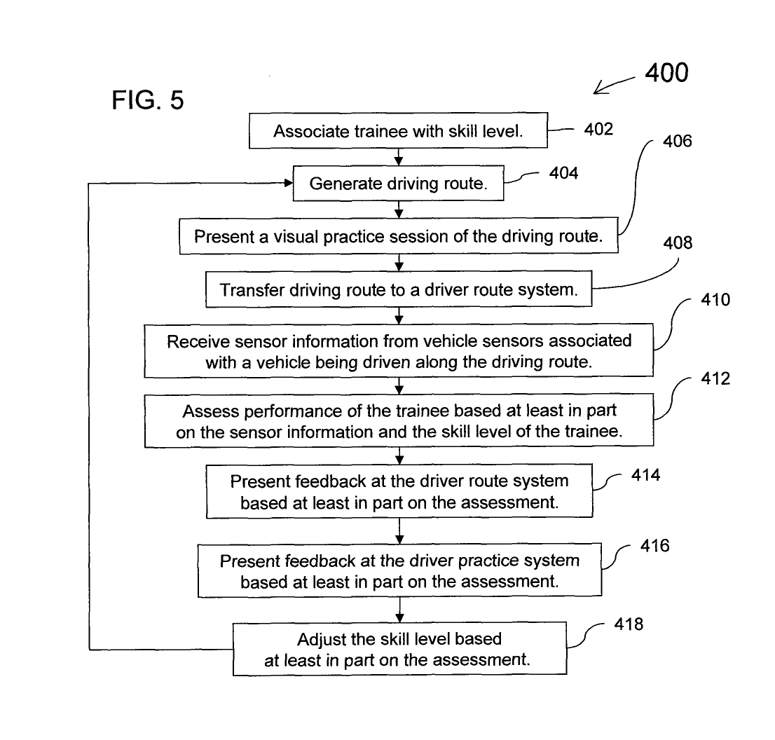

FIG. 5 depicts a flow chart 400 of exemplary steps for training driver trainees in accordance with aspects of the present invention (e.g., the generation of assignments for on-road instruction and practice that match the trainee's individual characteristics, experience and performance with the demands, challenge, and complexity of the driving tasks to ensure optimal training and safety). To facilitate description, the steps will be described with reference to the systems described above and with reference to FIGS. 2-4. It will be understood by one of skill in the art from the description herein that the steps of flow chart 400 may be performed by other systems and that one or more of the steps may be altered and/or omitted in accordance with some aspects of the present invention. Moreover, the sequences of steps shown in the drawing figures do not necessarily represent the only sequences anticipated in accordance with the invention. In some instances, steps may be done simultaneously or in a different order than being illustrated.

At step 402, an individual is associated with a mastery level. In an exemplary embodiment, the individual is associated with the mastery level according to expectations for those who have similar baseline characteristics (e.g., age, experience, disability) or training goals (e.g., licensure, rehabilitation, certification). For example, an individual learning to drive a vehicle may be associated with a skill mastery level defined as an ordinal or interval-ranked measurement skill mastery level such as, for example, “beginner” or “1” for someone just learning to drive, up to “skilled” or “10” for someone that has successfully completed their driver training and has received his license. In an exemplary embodiment, processing system 200 may provide the opportunity for interactive individual factor assessments and determination of mastery levels that are used as input to prescribe the individualized instruction prescriptions (e.g., on and/or off road assignments and/or training activities). The mastery level may be based at least in part on input of another individual such as a parent and/or driving instructor and driving experience. Levels may be defined based on personal characteristics (for example, disability), performance on intake and interim assessments, performance during skill training, and overall performance goals and the steps needed to achieve these goals.

The individual may have multiple skill, e.g., mastery (performance), levels. For example, the individual may have one mastery level associated with a particular driving environment and a different mastery level associated with another driving environment, or one mastery level on skills such as scanning and hazard avoidance with a different level for knowledge and attitudes and behaviors (for example, sensation seeking and perception of risk). Exemplary environments include outside vehicle condition environments, vehicle condition environments, and in-vehicle condition environments. Outside vehicle condition environments may include road type conditions (e.g., residential, urban, highway, etc.), weather conditions (e.g., raining, windy, etc.), and/or time of day conditions (e.g., night time or day time). Vehicle condition environments may include operating parameters or characteristics of the vehicle (e.g., manual, automatic, low speed, high speed, hauling cargo, etc.). In-vehicle conditions may include conditions within the vehicle (e.g., radio volume, number of passengers, ambient noise level, etc.).

At step 404, a driving route (i.e., on-road intervention/assignment) is generated. In an exemplary embodiment, processing system 200 of base system 102 may generate the driving route. In an alternative embodiment, the driving route may be generated at a remote system 106 based on input from processing system 200 of base system 102, and then transferred to processing system 200 of base system 102.

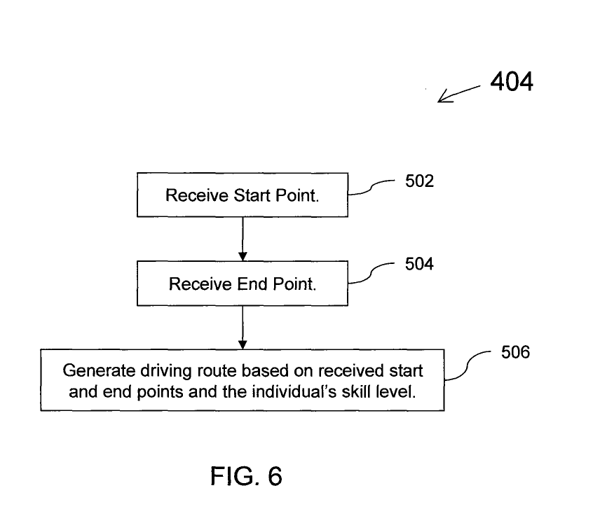

FIG. 6 depicts a flow chart of exemplary steps for generating a driving route in step 404. At step 502, a start point is received. The start point corresponds to a physical location from which the vehicle will be driven, e.g., an address, and may be received by the processing system 200 from an individual via one of the input devices 208. At step 504, an end point is received. The end point corresponds to another physical location to which the vehicle will be driven, e.g., an address, and may be received by the processing system 200 from an individual via one of the input devices 208.

At step 506, a driving route is generated based on the received start and end points. In an exemplary embodiment, the processing system 200 and/or a processing system in a remote system 106 generates the driving route. The driving route may include a map visually depicting the driving route and/or a text print out textually presenting the step-by-step or turn-by-turn directions for the driving route. The driving route may be generated using a system such as Yahoo! Local Maps available from Yahoo! Inc. of Sunnyvale, Calif., USA or Google Maps available from Google Inc. of Mountain View, Calif., USA, or a modification thereof that will be understood by one of skill in the art from the description herein.

Generation of the driving route may be based on the mastery level of the trainee that will be driving the vehicle. If the trainee is a relatively inexperienced driver (e.g., a level “1”), a driving route may be selected or calculated that excludes certain road conditions or environments that are considered too advanced for the individual. For example, the driving route may be generated such that the driving route is not too challenging, e.g., no freeways and/or portions where the speed limit is greater than 45 miles per hour. The driving route may further be based on input from a driving instructor, and may be designed to add specific maneuvers. For example, the driving instructor may indicate that the trainee needs training on handling left turn maneuvers, in which case a driving route may be generated having additional left turns randomly inserted rather than a driving route that is the shortest in distance or time.

The driving route may be selected such that the mastery level of the trainee is appropriate for all segments. This may be implemented by, for example, modifying the route and associated turn-by-turn directions such that each segment of a road map is associated with a minimum driving level. In accordance with this embodiment, when a driving route is generated, only segments associated with the characteristics of a maximum challenge being below the skill mastery (performance) level of the trainee are selected to form the driving route. Such discrimination of challenge may include but is not limited to: road type, maximum speed or speed limit, number of lanes, congestion, construction, accidents, etc. The map generator may balance safety and challenge to build skills in a prescribed, developmentally appropriate manner. The output map prescribing the route may include segments of the driving route associated with a driving level (e.g., color coded, such as green for the trainee and red where a more experienced driver must drive). Based on the skills and level of the trainee, the route may require changes in drivers (for example, a trainer may need to drive the trainee on the highway to get to a lower mastery level environment that is appropriate for the trainee).

As an example, a trainee generating a route to drive from the Patent Office at 401 Dulany St., Alexandria, Va., USA to the White House may enter 401 Dulany St., Alexandria, Va. as a start point and White House as an end point into a system such as Yahoo! Maps, which generates an exemplary driving route such as:

Start at 401 DULANY ST, ALEXANDRIA going toward JAMIESON AVE

Turn Left on DUKE ST (VA-236 W)—go 1.4 ml

Turn Right on N QUAKER LN (VA-402)—go 1.3 ml

Turn Left on KING ST (VA-7 W)—go 0.6 ml

Take ramp onto 1-395 N toward WASHINGTON—go 4.9 ml

Take Left fork onto US-1 N toward DOWNTOWN—go 1.1 ml

Continue on 14TH ST NW—go 0.2 ml

Turn Left on PENNSYLVANIA AVE NW

Turn Right on 15TH ST NW

Turn Left on ALEXANDER HAMILTON PL NW (Gate access required)

Turn Right on E EXECUTIVE AVE NW—go 0.2 ml

Turn Left on PENNSYLVANIA AVE NW

Turn Left on a local road

Arrive at THE WHITE HOUSE, on the Left

This driving route has 14 segments. Each segment may have information associated with it, such as typical acceleration ranges in one or more directions, acceptable speed of travel, etc. One or more of the illustrated segments may have multiple sub-segments. For example, segment 5 “Take ramp onto 1-395 N toward WASHINGTON—go 4.9 ml,” may have multiple sub-segments to accommodate the various turns and traffic patterns along the 4.9 miles of this segment.

The segment information may be supplemented with additional information for communication to the driver and/or instructor (either audibly or visually) such as “INTERSTATE ROAD—INCREASED CHALLENGE DUE TO TRAFFIC SPEED, REMEMBER TO PRACTICE GOOD MERGING INTO TRAFFIC SKILLS” or “LOCAL ROAD—INCREASED CHALLENGE DUE TO PEDESTRIANS AND NARROW ROADS, REMEMBER TO PRACTICE LEARNED SCANNING SKILLS. USE THIS PORTION OF THE ROUTE TO WORK ON IMPROVING LEFT-TURNING SKILLS.” It is contemplated that Census Feature Classification Codes CFCC may be used to determine routes with a hierarchy of challenge and complexity. The CFCC are an example of a standard road classification system that may be used to differentiate road types. The CFCC may be obtained in the form of TIGER/Line® files available from the U.S. Census Bureau. The CFCC is a three-character alphanumeric code. The first character is a letter describing the feature class; the second character is a number describing the major category; and the third character is a number describing the minor category.

Alternatively, the driving route may be selected from predefined driving routes defined by a driving instructor, driving school, or driving agency that are appropriate for each mastery level, for example.

The generation/selection of the driving route may additionally be based on mental or physiological characteristics of the driver, such as an attention deficit disorder, a head injury, or a visual impairment. For example, an experienced driver who suffered a head injury and is in rehabilitation may be provided with a different route than a first time driver with no impairments. This may be accomplished through the use of different standardized training protocols available for selection, e.g., one for an experienced driver with a head injury and one for a first time driver with no impairments.

In an exemplary embodiment, routing options for the driving route include one or more of the following: (I.) from a start point, drive for distance, pull over (instructor/mentor drives back), (II.) from start point, drive for time, pull over (instructor/mentor drives back), (III.) from start point, drive for distance, return to start point on different streets (tour-distance), (IV.) from start point, drive for time, return to start point on different streets (tour-time), (V.) from start point, drive for distance, 3 point turn, return to start point on same streets (up and back-distance), (VI.) from start point, drive for time, 3 point turn, return to start point on same streets (up and back-time), (VII.) from start point, to destination point driveway, back out to turn around, return to start point on same streets (there and back), (VIII.) from start point, to destination point, return to start point on different streets (there and work back), (IX.) from start point, via a series of intermediate “way points”, finish at destination point (multi-stop trip), (X.) from start point, via a series of way points, return to start point (multi-stop round trip).

Additionally, locations for start point, destination point, and way points can be specified in one or more of the following ways: (I.) by address: Street Address, Town, State, Zip-Code, (II.) by point of interest: e.g. school, shopping mall, parking lot, park, etc., (III.) by latitude/longitude: locating with a mouse and click on map, (IV.) by selecting from a list of named locations—the named location(s) capabilities will allow the user to identify a location on the map, name the location, and save it (name and latitude/longitude coordinates) in the database for subsequent reuse and enable each user to view, map, select, route from, route to, or route among from their named locations, as well as maintain their list of named locations. The named location maintenance includes editing capabilities for renaming and moving the location, and deleting the name location from their list.

Each of the above routing options III-X may be further specified to achieve: either shortest route (based on total distance) or quickest route (based on road speed limit, one-ways and time of day restrictions, and impacts of real time or predictive traffic patterns), and valid combinations of the following risk avoidance/driving challenge control prohibitions and restrictions. That is, specific attributes of road segments will be identified, selected, weighted and turned into “impedances” and “barriers” that add to the cost of traversing the segment as part of a particular route alternative. For example, the highest level of impedance, cost, or “relative or absolute barrier” to travel may correspond with lowest driving risk and level of driving challenge.

Impedances that can affect route challenge may include prohibitions (e.g., treated as absolute barriers to route navigation) and restrictions (e.g., treated as relative barriers to route navigation—things to avoid as much as possible, not an absolute prohibition, but minimize travel on). Prohibitions may include one or more of the following: (1.) No turns, (2.) No left turns, which cross traffic and increase accident risk, results in routes that only make right turns, (3.) No left turns onto certain classes of roads, (4.) No right turns onto certain classes of roads (e.g. avoiding highway on ramps), (5.) No U-turns, (6.) No travel on certain classes of roads (e.g. highways, major roads), (7.) No travel across certain classes of roads, (8.) No travel on roads with speeds above specified threshold, (9.) No travel on routes traversing intersections identified as high-risk, (10.) No travel on routes past certain kinds of high-volume or high-risk traffic features (e.g. schools, movie theaters, parking lots, construction, accidents, road closures, or events), (11.) No merging onto certain class roads, (12.) No travel out of state, (13.) No travel on road segments interactively identified by the user on the map.

Restrictions one or more of the following: (1.) Minimize left turns, (2.) Minimize left turns onto certain classes of roads, (3.) Minimize routing across certain classes roads, (4.) Minimize merging onto certain classes of roads, (5.) Minimize routing on certain classes of roads (e.g. major roads), (6.) Minimize routing on certain roads based on ancillary traffic attributes and/or construction data attributes, (7.) Minimize routing on roads above certain speed, (8.) Minimize routing through high-risk intersections, (9.) Minimize routing past certain kinds of high-volume traffic features (e.g. schools, movie theaters, parking lots, construction, accidents, road closures, or events), and (10.) Minimize toll roads.

Additionally, the route challenge may be based on one or more of the following expansions: (1.) Maximize left turns, (2.) Maximize left turns onto certain classes of roads, (3.) Maximize routing across certain classes roads, (4.) Maximize merging onto certain classes of roads, (5.) Maximize routing on certain classes of roads (e.g. major roads), (6.) Maximize routing on certain roads based on ancillary traffic attributes and/or construction data attributes, (7.) Maximize routing on roads above certain speed, (8.) Maximize routing through high-risk intersections, (9.) Maximize routing past certain kinds of high-volume traffic features (e.g. schools, movie theaters, parking lots, construction, accidents, or events), (10.) Maximize toll roads.

Referring back to FIG. 5, a simulation of the driving route is presented at step 406. This allows a trainee to visualize the driving route in a “safe” simulated environment for driving skills development exercises prior to actually driving the vehicle or for review after the on-the-road practice session. In an exemplary embodiment, the driving route is presented by the processing system 200 on display 216. Optionally, speaker 218 may be employed to add sound, e.g., traffic related noises.

The simulation may be a two dimensional (2D) or three dimensional (3D) representation of the driving route. In an exemplary embodiment, a 2D representation is generated from a geographical browser such as Google Maps Street View available from Google Inc. Depending on purpose and skill level training, the geographical browser may show the driving route at a predetermined rate (which may be adjustable by the individual) or the individual may interact with the geographical browser, e.g., through driver interface 220, to control movement within the 2D environment of the geographical browser. In another exemplary embodiment, the route might be programmed in a driving simulator.

In embodiments where the individual may interact with the geographical browser, the base system may assess the performance of the individual and the base system 102 may provide an indication to the individual suggesting that the individual is ready to actually drive a vehicle along the driving route or should continue using the base system 102, for example.

At step 408, the driving route is transferred to the mobile system 104. In an exemplary embodiment, the base system 102 generates the driving route and transmits the generated driving route, e.g., via transceiver 206 of processing system 200, for receipt by mobile system 104, e.g., via transceiver 308. The driving route may be transferred directly from base system 102 to mobile system 104 or indirectly via one or more remote systems 106.

In an alternative embodiment, the driving route may be generated independently at mobile system 104, e.g., as described above with reference to FIG. 6. In this case, step 408 may be omitted.

At step 410, sensor information associated with the vehicle being driven by the individual along the driving route is received. The sensor information may be generated by sensor system 302. The sensor information may then be transmitted from sensor system 302 of mobile system 104, e.g., via transceiver 308 of interface system 300, to base system 102, e.g., via transceiver 206 of processor system 202. The information may be transferred directly or indirectly, e.g., via one or more remote system(s).

The sensor information may include acceleration information along at least one axis from accelerometer(s) 318. For example, the sensor system may determine acceleration of the vehicle forward and backward and from side to side. Additionally, the sensor information may include global position system (GPS) information for associating sensor information with driving route information.

At step 412, the driving performance of the trainee is assessed based at least in part on the sensor information and the mastery level of the trainee. In an exemplary embodiment, the base system 102 assesses the performance of the trainee based on the sensor information collected from the sensor system 302 for each segment/sub-segment of the driving route. An algorithm may be used to assess the driving performance of the trainee. In addition, a database may track the student's activities and performance (for licensing agencies that require hours of practice, for example, or to provide incentives to the trainee for good performance). Further, each trainee's data could be linked so that the systems could be analyzed in aggregate to improve algorithms and decisions.

In an exemplary embodiment, the mobile system 104 assesses trainee performance during the segments/sub-segments of the driving route while the trainee is driving the vehicle along the driving route. As described below with reference to step 414, the mobile system may provide feedback to the trainee driving the vehicle and/or an individual accompanying the trainee driving the vehicle and/or someone remotely monitoring the student's progress. The mobile system 104 may assess the trainee utilizing a system such as the one described in U.S. Pat. No. 7,389,178 to Raz et al., entitled SYSTEM AND METHOD FOR VEHICLE DRIVER BEHAVIOR ANALYSIS AND EVALUATION, which is incorporated fully herein by reference. A system such as described by Raz et al. could process driving events using pattern-recognition to derive a sequence of driving maneuvers such as lane changing, passing, turning, and braking or other skills or behaviors assigned for instruction or practice. As the system was developed to monitor driving performance for safety rather than for use as a training aid, appropriate novel modifications may be needed. Exemplary modifications include evaluation of performance for the specific skills or behaviors assigned for instruction or practice. In addition, the feedback should be appropriate not only to the assignment, but also should take into account the driving environment in which the skill or behavior was performed and the trainee's skill mastery level. These evaluation data could be transferred to base system 102 for review by the trainee after the drive or to remote system 106 for monitoring by those interested in or involved in the progress of training. Interpretation of the performance data for assessing skill mastery may involve comparing each maneuver to skilled and un-skilled maneuver templates stored in a maneuver library, e.g., in memory 306, which are combined in a weighted fashion.

Additionally, the driving performance may be based on input from another individual accompanying the trainee being assessed along the driving route. For example, a parent and/or driving instructor may provide a subjective assessment of the trainee's driving (e.g., “made me feel uneasy”), which may be factored into the assessment of the trainee. In one embodiment, if the assessment by the mobile system 104 based on the objectives parameters associated with the driving maneuvers are “borderline,” the subjective parameters provided by the accompanying individual may be used to refine the evaluation.

The base system 102 may assess individual segments/sub-segments of the driving route after the trainee has completed the driving route in a manner similar to the mobile system 104 described above. The base system 102 may provide a detailed is assessment of the entire driving route as opposed to the current maneuver or a series of maneuvers by the mobile system 104. An algorithm may be employed to assess the driving performance of the trainee. An exemplary algorithm may be weighted based on different maneuvers. For example, starting maneuvers and stopping maneuvers may contribute to 20 percent of the assessment, lane change maneuvers (including proper signaling and lateral acceleration) may contribute to 40 percent of the assessment, turning maneuvers may contribute to 20 percent of the assessment, and subjective input from the accompanying individual may contribute to 20 percent of the assessment. If the algorithm indicates that the trainee performed the maneuvers above a predefined level, the trainee may be assessed as having successfully completed their current mastery level. This assessment can be based on a point total, or percentage of maneuvers that are competed properly, for example.

As an illustrative example, the trainee may have a beginner mastery level. In accordance with this mastery level, one or more parameters may be defined, e.g., forward acceleration should not exceed a predefined threshold value and the speed around a turn should not exceed another predefined threshold value. If the beginner trainee accelerates too quickly or goes around a turn too fast, the trainee's performance assessment score will decrease. On the other hand, if the trainee accelerates within an acceptable range and proceeds around a corner at a proper speed, the trainee's assessment performance score would increase. If the trainee has a higher mastery level, the threshold values may be adjusted to higher and/or more stringent standards.

At step 414, the mobile system 104 presents feedback while the trainee is driving the vehicle along the driving route (i.e., feedback in “real time”). In an exemplary embodiment, the mobile system provides visual feedback to the trainee using a known technique. For example, the mobile system 104 may illuminate indicators 315 such as green, yellow, and red light emitting diodes (LEDs) corresponding to acceptable, borderline, and unacceptable driving, respectively. The indicators may reflect individual maneuvers or a cumulative qualitative assessment such that multiple driving maneuvers are taken into consideration. For example, one borderline maneuver after 20 acceptable driving maneuvers may still be displayed at a green indicator, whereas several borderline and/or unacceptable driving maneuvers may result in a transition to a yellow or red indicator.

The mobile system 104 may provide feedback to the accompanying individual in addition to, or instead of, the trainee. The feedback provided to the accompanying individual may be more detailed than the feedback provided to the trainee. For example, the mobile system may present feedback to the trainee, parent or other trainer via three LEDs as described above to prevent the trainee from being overwhelmed or distracted by too much feedback. In contrast, mobile system 104 may present graphic, auditory, or text information to the accompanying individual (i.e., non-driver), e.g., “last turn was taken too fast,” who may decide when/whether to provide this feedback to the trainee.

The mobile system 104 may also provide feedback to a remote system 106 operated by a third party such as a law enforcement agency. For example, if an assessment by mobile system 104 indicates the individual is driving erratically (suggesting reckless driving or driving under the influence, for example), a parent, law enforcement agency or driving instructor may be notified.

At step 416, the base system 102 presents feedback after the trainee has completed the driving route. The base system 102 may present feedback for the entire driving route to the trainee, e.g., via display 216. The base system 102 may enable the trainee to assess different aspects of the driving route, e.g., turning maneuvers, lane-changing maneuvers, etc. Additionally, the base system 102 may present feedback to a driving instructor, e.g., located at remote system 106 based on data originating from base system 102 or from mobile system 104.

At step 418, the trainee's mastery level(s) is/are adjusted based at least in part on the assessment. If the assessment performed by the base system 102 indicates that the driving route was completed successfully, e.g., 80 percent or better weighted average over the entire route and no categories of maneuvers less than 60 percent, the mastery level of the trainee may be increased. Alternatively, if the base system 102 determines that the trainee has not completed the driving route successfully, base system 102 may leave the mastery level unchanged or reduce the mastery level. In one embodiment, the base system 102 may track a number of hours the trainee has driven and/or the amount of driving under different conditions (e.g., time of day, location, weather conditions) and adjust the mastery level based in part on the number of hours and/or experience. The number of hours may include total hours and hours driven at night.

After the trainee's mastery level(s) is/are adjusted, steps 402-418 may be repeated, taking into account the current mastery level(s) in generating the route and assessing the individual.

The trainee's mastery level may be provided to a rewards/consequence system (not shown) to provide an incentive for the trainee. For example, the mastery level may be presented to a state's department of motor vehicles with the trainee required to achieve a predefined level of proficiency before being able to obtain an unrestricted drivers license in accordance with a government's licensing or graduated licensing system or to receive a level of certification from an agency, company, organization, or government. In another example, the mastery level may be presented to an insurance agency with reduced rates provided after a predefined level is achieved.

Systems in accordance with aspects of the invention not only present is feedback to the trainee and trainee's instructor, but process data to design subsequent training regimes for the driver. Modified routes can be designed over time, based on the driver's performance. This performance-based method of driver training can be implemented to make training progressively more and more advanced, until the driver reaches the mastery level necessary to drive independently.

In one exemplary embodiment, as a new trainee progresses through the system, the trainee will be assigned a level based on experience and performance on the road. Based on the level and other characteristics of the trainee, the system will suggest characteristics of the desired route for training. Utilizing existing GIS systems, the system will plan the route (with directions) for the trainee. The trainee and the trainee's trainer will have the option of visualizing the route through an integrated animation capability. Pre-drive on-line exercises may be suggested to prepare the trainee for the challenges of the route. While driving the route, existing in-vehicle technology will track the actual route taken, the quantity and quality of maneuvers, and other characteristics of the drive based on sensor data (GIS, accelerometer, and other available sensors—seat belt use, alcohol use, etc.). If desired, video and audio recording can be included. A graphical user interface (GUI) may provide feedback during this route, which can be modified for the specific application. During or after the route, the trainee and the instructor/supervisor will have the option of providing qualitative assessments and feedback. Feedback from in-vehicle technology and the trainee/instructor/supervisor may be sent to a central server via cellular or other technology for assessment of the quality and complexity of the drive to (a.) produce an automatic report, (b.) provide automatic guidance, (c.) alert necessary individuals about hazardous driving, and (d.) assign driver to current appropriate driving level which would restart cycle. The report may include multiple possible interfaces: (a.) Graphical User Interface mapping the performance on to the route taken and graphs or other figures to show progress (or lack thereof) and provide comparisons (with self and others), text and exercises, (b.) text/audio/video explanation and instruction delivered by preferred medium (phone, internet, print, fax, etc.), and (c.) link to rewards/consequences structure.

The present invention may be implemented as part of an integrated system for parent-supervised driver training with accurate just-in-time driver training information for parents that is individualized to their teen's needs and requires little additional effort beyond the time the parent spends in the car with the teen. Aspects of the invention solve the challenge for parents to effectively teach their teens to drive through the use of an integrated system that will solve the following challenges faced during parent-supervised driver training:

When is the driver ready to tackle learning/practicing a more complex driving is task or situation?

When is professional instruction needed because training progress is insufficient?

When is the driver ready to go for the on-the-road Driving Test?

When is the driver ready to have driving restrictions lifted?

What remedial training might the driver need?

When is the driver ready to go for the Unrestricted License?

One or more of the system components and method steps described above may be implemented in one or more software modules. In this embodiment, one or more of the functions of the various components/steps may be implemented in software for performance by a general or specific purpose computer. This software may be embodied in a medium readable by a computer (i.e., computer readable medium) such as, for example, a magnetic disc, an optical disk, a memory card, a hard drive, processor cache, or other tangible medium capable of storing software.

Although the invention is illustrated and described herein with reference to specific embodiments, the invention is not intended to be limited to the details shown. Rather, various modifications may be made in the details within the scope and range of equivalents of the claims and without departing from the invention. For example, although the invention is described above for use with a conventional vehicle such as an automobile or motorcycle, it is contemplated that the present invention can be extended for use with essentially any type of motorized vehicle. Accordingly, it is intended that the appended claims cover all such variations as fall within the spirit and scope of the invention.

What is claimed:

1. A driver training method comprising the steps of:
storing a plurality of standardized training protocols in an electronic knowledge resource library;
enabling selection and modification of the plurality of standardized training protocols to train driving trainees;
tracking driving statistics associated with the driving trainees trained using the selected and modified standardized training protocols; and
transforming one or more of the plurality of standardized training protocols stored in the electronic knowledge resource library using a computer based on the tracked driving statistics.

2. A driving training system comprising:
a knowledge resource library including a plurality of standardized training protocols; and
a computer system implementing a driving training program that trains driving trainees, the driving training program selecting and modifying one or more standardized training protocols from the plurality of standardized training protocols in the knowledge resource library.

3. The system of claim 2, the driving training program comprising:
a driving plan customized to a driving trainee from one of the selected and modified standardized training protocols, the driving plan including a plurality of mastery levels and assignments for progressing through the plurality of mastery levels.

4. The system of claim 3, further comprising:
a quality improvement plan generator, the quality improvement plan generator transforming the standardized training protocols based on driving statistics of the driving trainee trained using the modified and customized standardized training protocol.

5. A driver training method for use with an individual having a mastery level, the method comprising the steps of:
receiving vehicle sensor information, at a computer system, from a vehicle being driven along a driving route by the individual;
assessing performance of the individual based at least in part on the received sensor information and the mastery level of the individual; and
adjusting, by the computer system, the mastery level of the individual based at least in part of the assessed performance of the individual.

6. The method of claim 5, further comprising the step of:
presenting a simulation of the driving route by the computer system for viewing by the individual prior to driving the vehicle along the driving route.

7. The method of claim 5, further comprising the steps of:
receiving routing option information; and
generating the driving route at the computer system based at least in part on the routing option information and the mastery level of the individual.

8. The method of claim 7, further comprising the step of:
identifying training needs of the individual, wherein the generating step generates the driving route based at least in part on the routing option information, the mastery level of the individual, and the training needs of the individual.

9. The method of claim 7, further comprising the step of:
transferring the generated driving route from the computer system to a mobile computer system for use at the vehicle while the vehicle is being driven along the driving route.

10. The method of claim 5, further comprising the step of:
generating the driving route based at least in part on the mastery level of the individual.

11. The method of claim 10, wherein the generating step is further based on input provided by a driving instructor.

12. The method of claim 10, further comprising the step of:
identifying training needs of the individual, wherein the generating step generates the driving route based at least in part on the mastery level of the individual and the training needs of the individual.

13. The method of claim 5, further comprising the step of:
presenting individual feedback to the individual while the vehicle is being driven along the driving route based at least in part on the mastery level of the individual.

14. The method of claim 13, further comprising the step of:
presenting supervisor feedback to an accompanying individual while the vehicle is being driven along the driving route based at least in part on the mastery level of the individual.

15. The method of claim 5, further comprising the step of receiving qualitative feedback for the individual driving the vehicle along the driving route from an accompanying individual, wherein the assessing is further based on the received qualitative feedback.

16. The method of claim 5, wherein the mastery level of the individual is associated with a particular environment and the individual has a different mastery level for each environment.

17. The method of claim 16, wherein the particular environment includes an outside vehicle condition.

18. The method of claim 16, wherein the particular environment includes a vehicle condition.

19. The method of claim 16, wherein the particular environment includes an in-vehicle condition.

20. The method of claim 5, further comprising the step of:
tracking a number of hours the individual has driven and wherein the adjusting step is further based on the number of hours.

21. The method of claim 5, wherein the adjusting step comprises:
adjusting, by the computer system, the mastery level of the individual based at least in part of the assessed performance of the individual and driving experience of the individual.

22. A driver training system for use with an individual having a mastery level, the system comprising:
a receiver that receives vehicle sensor information associated with a vehicle being driven along a driving route by the individual;
a processor coupled to the receiver that assesses performance of the individual based at least in part on the received sensor information and the mastery level of the individual and adjusts the mastery level of the individual based at least in part of the assessed performance of the individual.

23. The system of claim 22, further comprising:
a display that receives data from the processor that presents a simulation of the driving route for viewing by the individual prior to driving the vehicle along the driving route.

24. The system of claim 22, wherein the processor further receives routing option information and generates the driving route based at least in part on the routing option information and the mastery level of the individual.

25. The system of claim 24, wherein the processor further identified training needs of the individual and generates the driving route at the base system based at least in part on the routing option information, the training needs of the individual, and the mastery level of the individual

26. The system of claim 24, further comprising:
a transmitter coupled to the processor to transfer the generated driving route to a mobile system for use at the vehicle while the vehicle is being driven along the driving route.

27. The system of claim 22, wherein the processor adjusts the mastery level of the individual based at least in part of the assessed performance of the individual and the driving experience of the individual.

28. A computer readable medium including software that is adapted to control a computer to implement a driver training method, the driver training method comprising the steps of:
receiving vehicle sensor information, at a computer system, from a vehicle being driven along a driving route by the individual;
assessing performance of the individual based at least in part on the received sensor information and the mastery level of the individual; and
adjusting, by the computer system, the mastery level of the individual based at least in part of the assessed performance of the individual.

29. The computer readable medium of claim 28, the method further comprising the step of:
presenting a simulation of the driving route on the computer system for viewing by the individual prior to driving the vehicle along the driving route.

30. The computer readable medium of claim 28, the method further comprising the steps of:
receiving routing option information; and
generating the driving route at the computer system based at least in part on the routing option information and the mastery level of the individual.

31. The computer readable medium of claim 30, the method further comprising the step of:
identifying training needs of the individual, wherein the generating step generates the driving route based at least in part on the routing option information, the mastery level of the individual, and the training needs of the individual.

32. The computer readable medium of claim 30, the method further comprising the step of:
transferring the generated driving route to a mobile computer system for use at the vehicle while the vehicle is being driven along the driving route.

33. The computer readable medium of claim 30, the method further comprising the step of:
generating the driving route based at least in part on the mastery level of the individual.

34. The computer readable medium of claim 28, the method further comprising the step of:
presenting individual feedback to the individual while the vehicle is being driven along the driving route based at least in part on the mastery level of the individual.

35. The computer readable medium of claim 34, the method further comprising the step of:
presenting supervisor feedback to an accompanying individual while the vehicle is being driven along the driving route based at least in part on the mastery level of the individual.

36. The computer readable medium of claim 28, the method further comprising the step of:
receiving qualitative feedback for the individual driving the vehicle along the driving route from an accompanying individual, wherein the assessing is further based on the received qualitative feedback.

37. The computer readable medium of claim 28, the method further comprising the step of:
providing assessed performance information to a driving instructor.

38. The computer readable medium of claim 28, the method further comprising the steps of:
tracking a number of hours the individual has driven and wherein the adjusting step is further based on the number of hours.
